(19) United States
(12) Patent Application Publication
(10) Pub. No.: US 2011/0274922 A1
(43) Pub. Date: Nov. 10, 2011

(54) COLORED AND LAMINATED METAL PLATE FOR CONTAINER

(75) Inventors: Yoshihiko Yasue, Chiba (JP); Hiroki Iwasa, Kanagawa (JP); Junichi Kitagawa, Hiroshima (JP); Yoichiro Yamanaka, Hiroshima (JP)

(73) Assignee: JFE STEEL CORPORATION, Tokyo (JP)

(21) Appl. No.: 13/127,368

(22) PCT Filed: Nov. 12, 2009
(86) PCT No.: PCT/JP2009/069591

§ 371 Date: Jul. 21, 2011

(30) Foreign Application Priority Data
Nov. 14, 2008 (JP) 2008-292744

(51) Int. Cl. B32B 7/12

(52) U.S. Cl. 428/354

(57) ABSTRACT

A colored laminated metal plate for containers includes a metal plate having one or both surfaces coated with a film for lamination in which a colored adhesive layer is coated to a polyester resin film. The colored adhesive layer contains a polyester resin as a main component and further contains an etherified amino resin, an epoxy resin, a strong acid compound, and a coloring agent. The colored laminated steel sheet is excellent in deep drawability, adhesion after forming, rust resistance of a damaged portion, and so on. When the steel sheet is applied to manufacturing of a container such as a can, retort whitening of the laminate film hardly occurs, and the design properties of appearance can be maintained.

### TECHNICAL FIELD

The present invention relates to a colored laminated metal plate for containers, in particular, a colored laminated metal plate for containers excellent in deep drawability, adhesion after forming, rust resistance of a damaged portion, design properties after retort sterilization treatment, and so on.

### BACKGROUND ART

Coated metal plates have been conventionally used for metal cans as containers, but the coating processes conducted by can-manufacturers are complicated and low in productivity. In addition, in cases of using solvent-based paint, since a large amount of the solvent volatilizes during drying/printing after coating, environmental problems, such as unavoidable discharge of the solvent, reside therein. Therefore, recently, a laminated metal plate in which a thermoplastic resin film is thermal compression bonded to a heated metal plate has been used. In particular, a laminated metal plate coated with a polyester resin film exhibits excellent performance in the aspect of food hygiene and therefore has been widely used.

Conventionally, metal cans serving as containers made of coated metal plates are imparted with design properties by coating gold, white, or other color. When these plates are replaced by laminated metal plates, a coloring agent such as pigment is added to a laminate film for coloring the film. But, this has problems, for example, (i) the pigment that can be used is limited from the viewpoint of food hygiene and (ii) the washing of film-forming facilities after the use of pigment takes a huge amount of time, resulting in a reduction in productivity.

As the method for avoiding the problem caused by adding coloring pigment to such a film, it is known a method in which a coloring agent is applied to a surface of a transparent film (clear film) as a post-process to form a coloring layer. As the method for forming the coloring layer, the following two methods are known. In a first method, a coloring agent is applied to the outermost layer of a film. In a second method, in order to dispose a coloring layer between a film and a metal plate, the coloring layer is applied to the film surface on the metal plate side. The first method has problems such that the layer applied with the coloring agent is easily damaged. On the other hand, in the second method, since the coloring layer disposed between the film and the metal plate also functions as an adhesive, the film-forming process can be partially omitted, resulting in a reduction in manufacturing cost and an improvement in productivity.

Patent Documents 1 to 6 disclose adhesives for improving film adhesion and disclose films for lamination and laminated metal plates employing these adhesives. In the adhesives and adhesive layers disclosed in these Patent Documents, a complex system of a polyester resin and a thermosetting epoxy resin or an epoxy resin is a main component.

### REFERENCE DOCUMENTS

[Patent Document 1] Japanese Unexamined Patent Application Publication No. 4-266984

[Patent Document 2] Japanese Unexamined Patent Application Publication No. 8-199147

[Patent Document 3] Japanese Unexamined Patent Application Publication No. 10-183095

[Patent Document 4] Japanese Unexamined Patent Application Publication No. 2002-206079

[Patent Document 5] Japanese Unexamined Patent. Application Publication No. 2007-83525

[Patent Document 6] Japanese Unexamined Patent Application Publication No. 2007-185915

### DISCLOSURE OF INVENTION

### Problems to be Solved by the Invention

However, laminated metal plates employing the techniques disclosed in Patent Documents 1 to 4 are inferior in deep drawability and therefore cannot be applied to the use in two-piece cans. This is because since the epoxy resin of the adhesive layer cannot follow elongation deformation in the height direction of the can to constrain deformation of the material, the material is ruptured in the drawing process. In Examples disclosed in Patent Documents 1 to 4, can-manufacturing processability or deep drawability is not evaluated. This also means that these techniques are not suitable for the use in two-piece cans requiring a deep drawing process. In Patent Documents 5 and 6, DRD can formability is evaluated in Examples. However, since the main components of adhesive layers are epoxy resins, it is suggested that some heat treatment such as retort treatment after formation of cans is necessary for obtaining sufficient adhesion.

In addition, application of a laminated metal plate to a food can'or a drink can has quality problems as follows: In a laminated metal plate in which a thermoplastic polyester resin film is thermal compression bonded to a metal plate, retort sterilization treatment causes a change in color (hereinafter, this is sometimes referred to as “retort whitening”), and improvement thereof has been conventionally required. The retort sterilization treatment is performed in water vapor at a high temperature of about 130° C. On this occasion, in many cases, formation of fine voids is observed in the film on the outside of a can. It is thought that the fine voids scatter light incident on the outside film of the can to give a white cloudy appearance. Therefore, in order to prevent the degradation in appearance of the outside of a can associated with the retort sterilization treatment, it is necessary to prevent the formation of voids in the film on the outside. Regarding a generation mechanism of voids in the retort sterilization treatment, Japanese Unexamined Patent Application Publication No. 2005-161621 describes as follows.

The voids formed in the outside film of a can have the following characteristics. First, since voids are not formed by heating a can in a dry heat environment of 130° C., it is suggested that water vapor is obviously involved in the voids-generating mechanism. In addition, when an empty can, not being filled with contents, is subjected to the retort sterilization treatment, voids are not formed. The formation of voids is observed in not the entire area in the thickness direction of the outside film of a can, but near the interface where the outside film of the can is in contact with a metal plate. Furthermore, there is a large difference in degrees of voids generation between the upper end and the lower end. The voids are observed in the lower end, but are hardly observed in the upper end.

It is suggested by the above-described characteristics that voids are formed in the outside film of a can during retort sterilization treatment by the following mechanism.

FIG. 3 shows a mechanism of forming voids in the outside film of a can. As shown in FIG. 3, a can end is exposed to high temperature water vapor from the beginning of retort sterilization treatment, and part of the water vapor penetrates into the outside film of the can and reaches near the interface with a metal plate. Then, since the vicinity of the interface between the outside film of the can and the metal plate is cooled by the contents packed in the can at the beginning of the retort sterilization treatment, the water vapor penetrated into the interface is condensed to water in the outside film of the can. Then, the temperature of the contents increases with the duration of the retort sterilization treatment, and the condensed water at the interface with the metal plate is re-evaporated to form fine voids. It is supposed that part of the evaporated water vapor permeates through the outside film of the can to the exterior of the outside film of the can. However, the remaining water vapor in the outside film of the can causes deformation of the resin by volume expansion to form voids.

The voids are observed only near the interface with the metal plate. This may be caused by that the condensed water is re-evaporated near the interface and also by that the resin near the interface, which is melted by being in contact with the heated metal plate when a polyester film is laminated to the metal plate, is an amorphous resin being mechanically soft and having high deformability still after cooling and solidification, and, therefore, the resin is deformed by volume expansion of the condensed water associated with the evaporation, which readily form voids. On the other hand, the resin loses the amorphous property and obtains crystallinity with getting away from the interface with the metal plate. Consequently, the resin is hardly deformed, and voids are hardly formed.

In order to prevent the generation of voids formed by such a mechanism and to maintain fine appearance even after the retort sterilization treatment, Japanese Unexamined Patent Application Publication No. 2005-161621 proposes the following means. First, the resin constituting an amorphous polyester resin layer has a semi-crystallization time of 40 seconds or less at 130° C. Second, the outside film of a can has a water vapor permeation rate of 100 g/m²/24 hr or less. Since the semi-crystallization time of the resin constituting the amorphous polyester resin layer is 40 seconds or less at 130° C., the amorphous polyester resin layer is rapidly crystallized during the retort sterilization treatment, which is performed at about 130° C., the strength of the amorphous layer is increased, and formation of voids is prevented. The semi-crystallization time can be adjusted to 40 seconds or less by optimizing the resin composition. The semi-crystallization time at 130° C. can be adjusted to 40 seconds or less by complexing polybutylene terephthalate with polyethylene terephthalate at a ratio of polybutylene terephthalate of 40% or more. Actually, in a laminated metal plate having a film of such a resin composition coated by thermal compression, no whitening phenomenon by the retort sterilization treatment is observed, and it is confirmed that voids are not formed in the resin layer.

When a colored adhesive is applied to a film, a change in color is caused by a mechanism other than that of the change in color (retort whitening phenomenon) by the retort sterilization treatment disclosed in detail in Japanese Unexamined Patent Application Publication No. 2005-161621 described above. Since conventional adhesives are low in curing reaction rate, the thermal curing of the adhesive is insufficient in the manufacturing of a laminated metal plate, or an unreacted curing component remains in the resin layer after lamination. Therefore, curing reaction of the adhesive occurs during retort heat sterilization treatment after filling the can with contents, and thereby voids are formed near the interface between the film and the adhesive layer. It is suggested that such voids also cause a change in color.

In addition, in some cases, a damage reaching the base is formed in a laminate film on the outside of a can during can-manufacturing or handling. Such a case has a problem that rust occurs at the damaged portion when the can is left under humid environment, during storage as an empty can or during storage in a warehouse as a can filled with contents and seamed in a food company. If the rust further develops, detachment of the film occurs in the vicinity of the damage, which further accelerates rusting of the base. Also in a lacquered can, rust occurs at a damaged portion, but detachment of the coating hardly occurs, compared to the detachment of the film. Regarding inhibition of the rust development and film detachment in the laminated can, improvement is being required by can makers and food companies.

Accordingly, it is an object of the present invention to provide a colored laminated metal plate for containers being excellent in, for example, deep drawability, adhesion after forming, and rust resistance of a damaged portion and hardly causing retort whitening of the laminate film and being possible to maintain design properties of appearance.

### Means for Solving the Problems

The gists of the present invention are as follows.

[1] In a colored laminated metal plate for containers including a metal plate having one or both surfaces coated with a film for lamination in which a colored adhesive layer is coated to a polyester resin film,

the colored adhesive layer contains a polyester resin as a main component and further contains an etherified amino resin, an epoxy resin, a strong acid compound, and a coloring agent.

[2] In the colored laminated metal plate for containers according to the above [1], the colored adhesive layer contains a saturated polyester resin (A1) having a number average molecular weight of 5000 to 30000 and a Tg of 5 to 50° C., a saturated polyester resin (A2) having a number average molecular weight of 5000 to 30000 and a Tg of 51 to 100° C., an etherified amino resin (B), an epoxy resin (C) having a number average molecular weight of 500 to 5000, and a strong acid compound (D) of at least one selected from sulfonic acid compounds and amine neutralized sulfonic acid compounds. Based on 100 parts by mass of the total solid of the components (A1), (A2), (B), (C), and (D), the amount of the solid of the saturated polyester resin (A1) is 40 to 60 parts by mass, the amount of the solid of the saturated polyester resin (A2) is 20 to 40 parts by mass, the amount of the solid of the etherified amino resin (B) is 1 to 10 parts by mass, the amount of the solid of the epoxy resin (C) is 5 to 20 parts by mass, and the amount of the solid of the strong acid compound (D) is 0.01 to 10 parts by mass.

[3] In the colored laminated metal plate for containers according to the above [1] or [2], the polyester resin constituting the polyester resin film includes a main repeating unit of ethylene terephthalate.

[4] In the colored laminated metal plate for containers according to any of the above [1] to [3], the adhering amount of the colored adhesive layer is 0.1 to 5 g/m².

[5] In the colored laminated metal plate for containers according to any of the above [1] to [4], the polyester resin film has a thickness of 6 to 50 μm.

[6] In the colored laminated metal plate for containers according to any of the above [1] to [5], the epoxy resin contained in the colored adhesive layer is a phenol novolac epoxy resin.

[7] In the colored laminated metal plate for containers according to any of the above [1] to [6], the colored adhesive layer contains an organic pigment as the coloring agent in an amount of the solid of 1 to 10 parts by mass based on 100 parts by mass of the solid of the adhesive composition.

### Advantages

The colored laminated metal plate for containers of the present invention is excellent in deep drawability, film adhesion, adhesion after forming, rust resistance of a damaged portion, and so on, and hardly causes retort whitening of the laminate film, and can maintain the design properties of appearance.

### BRIEF DESCRIPTION OF DRAWINGS

FIG. 1 is an explanatory drawing schematically showing a cross section in the plate thickness direction of a colored laminated metal plate for containers of the present invention.

FIG. 2 is an explanatory drawing showing an example of laminating equipment for metal plate.

FIG. 3 is an explanatory drawing showing a mechanism of void generation in an outside film of a can.

### BEST MODES FOR CARRYING OUT THE INVENTION

The present inventors have conducted intensive studies in order to solve the above-mentioned problems and, as a result, have found that by laminating a metal plate with a laminate film that is a laminate of a polyester resin film and a colored adhesive layer containing a polyester resin (preferably a polyester resin having a specific number average molecular weight and a specific Tg (glass transition point)) as a main component, a specific component, and a coloring agent, excellent deep drawability and adhesion after processing/retort treatment can be obtained, in addition to basic characteristics such as processability and adhesion, while retort whitening of the laminate film (the resin film and the colored adhesive layer) can be effectively prevented during the retort heat sterilization treatment after filling a can with contents. That is, the colored adhesive provides blocking resistance during the lamination, and the thermal curing is immediately completed by the residual heat during the lamination. With this, excellent adhesion, heat resistance, base adhesion, water resistance, and retort whitening resistance can be obtained.

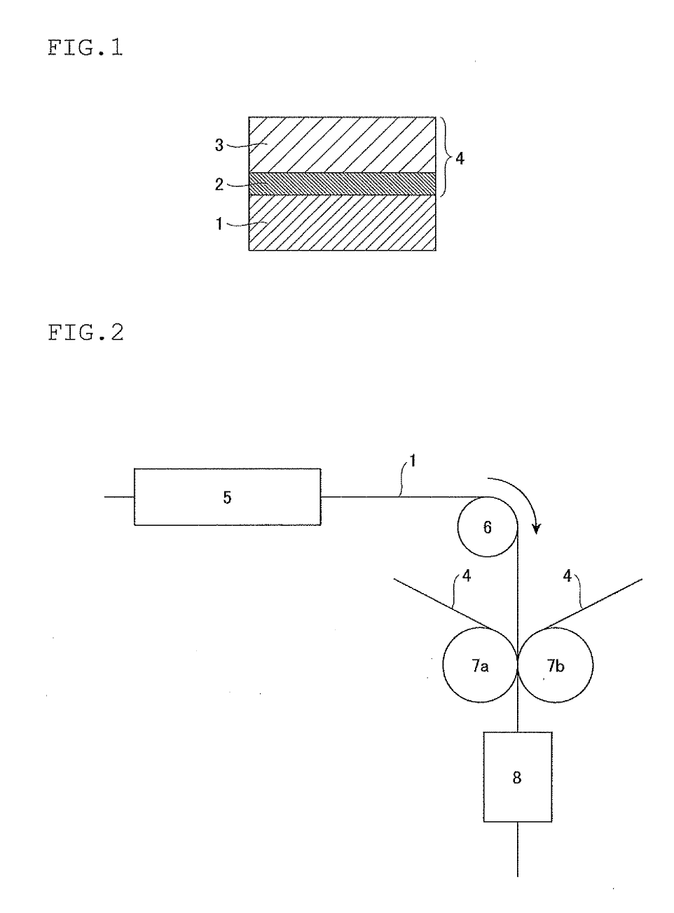

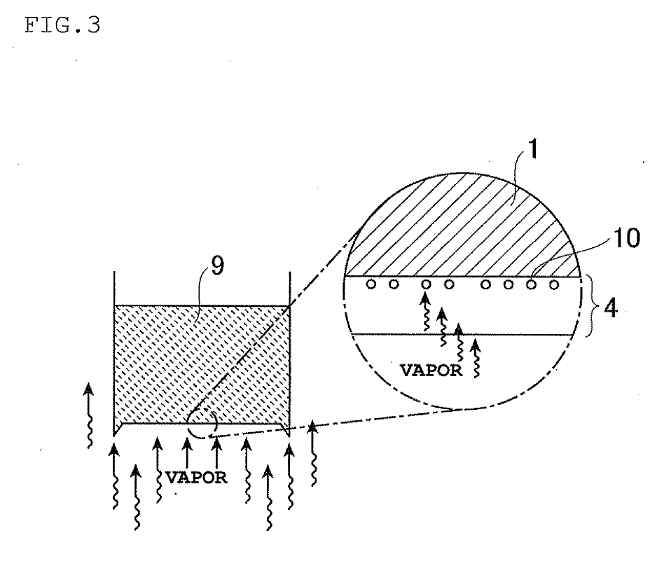

The colored laminated metal plate for containers of the present invention is a metal plate having one or both surfaces laminated with a film in which a colored adhesive layer is coated to a polyester resin film. The colored adhesive layer contains a polyester resin as a main component and further contains a coloring agent, an etherified amino resin, an epoxy resin, and a strong acid compound. FIG. 1 schematically shows a cross section in the plate thickness direction of the colored laminated metal plate for containers of the present invention.

As the metal plate serving as a basal material, for example, aluminum plates, soft steel sheets, and surface-treated steel sheets, which are widely used as can materials, can be used. In particular, a surface-treated steel sheet composed of a chromium metal and a hydrated chromium oxide, so-called tin free steel (TFS), is most preferred. The coating weight of the chromium metal and hydrated chromium oxide of TFS are not particularly limited, but are preferably in the ranges of 40 to 300 mg/m² and 5 to 30 mg/m², respectively, in terms of chromium, from the viewpoints of adhesion after processing and corrosion resistance.

Next, the colored adhesive layer in the film for lamination will be described.

In general, in application to cans, design properties are most important characteristic requirements. There is a tendency that brilliant colors such as gold are preferred as the color of the outer surface of a can. The brilliant color such as gold can be obtained by laminating a transparent film colored with yellow and red pigments onto a metal plate having brilliance. In addition, the brilliant color such as gold is required not to be discolored even after retort sterilization treatment.

However, as described above, the colored adhesive may cause a problem of retort whitening, that is, discoloration due to retort sterilization treatment. The present inventors have presumed that this is caused by that short-time heat treatment in the lamination process is insufficient for curing the colored adhesive, and thereby the curing reaction also occurs in the retort heat treatment. That is, it is presumed that the retort whitening of the adhesive colored to gold is caused by that the adhesive is cured in a state that the adhesive contains the remaining solvent and moisture, and therefore the cured adhesive layer is partially and unevenly expanded and discolored to cloudy brown. Therefore, in the colored laminated steel sheet for containers of the present invention, as a countermeasure for the retort whitening of the colored adhesive, an adhesive composition that can accelerate the curing in short-time heat treatment in the lamination process is employed as the adhesive contained in the colored adhesive layer.

The colored adhesive layer contains a polyester resin as a main component and also contains an etherified amino resin, an epoxy resin, a strong acid compound, and a coloring agent. By blending the etherified amino resin, the epoxy resin, and the strong acid compound to the polyester resin as the main component, the curing is accelerated in the short-time heat treatment in the lamination process, and the adhesion, retort whitening resistance, heat resistance, temporal stability, and durability can be achieved.

A further preferable composition of the colored adhesive layer contains a saturated polyester resin (A1) having a number average molecular weight of 5000 to 30000 and a Tg of 5 to 50° C., a saturated polyester resin (A2) having a number average molecular weight of 5000 to 30000 and a Tg of 51 to 100° C., an etherified amino resin (B), an epoxy resin (C) having a number average molecular weight of 500 to 5000, and a strong acid compound (D) of at least one selected from sulfonic acid compounds and amine neutralized sulfonic acid compounds. Based on 100 parts by mass of the total solid of the components (A1), (A2), (B), (C), and (D), the amount of the solid of the saturated polyester resin (A1) is 40 to 60 parts by mass, the amount of the solid of the saturated polyester resin (A2) is 20 to 40 parts by mass, the amount of the solid of the etherified amino resin (B) is 1 to 10 parts by mass, the amount of the solid of the epoxy resin (C) is 5 to 20 parts by mass, and the amount of the solid of the strong acid compound (D) is 0.01 to 10 parts by mass.

Each component constituting such a colored adhesive layer will be described in detail below.

Any polyester resin that is usually applied to a film for lamination may be arbitrarily used as the polyester resin in the main component of the colored adhesive layer, but in order to simultaneously achieve high processability and blocking resistance, it is preferred to use two types of saturated polyester resins, one having a low Tg and one having a high Tg. Specifically, a saturated polyester resin (A1) having a number average molecular weight of 5000 to 30000 and a Tg of 5 to 50° C. and a saturated polyester resin (A2) having a number average molecular weight of 5000 to 30000 and a Tg of 51 to 100° C. are preferably used in combination.

The saturated polyester resin (A1) having a number average molecular weight of 5000 to 30000 and a Tg of 5 to 50° C. is obtained by esterification reaction of a polybasic acid component and a polyol component of which at least one is trifunctional or more functional. As the polybasic acid component, mainly used are, for example, one or more dibasic acids such as phthalic acid anhydride, isophthalic acid, terephthalic acid, succinic acid, fumaric acid, adipic acid, azelaic acid, sebacic acid, and dimer acid and lower-alkyl esterification products of these acids. According to need, a monobasic acid such as benzoic acid, crotonic acid, or p-t-butylbenzoic acid or a polybasic acid being trifunctional or more functional such as trimellitic acid anhydride, methylcyclohexene tricarbonate, or pyromellitic acid anhydride may be contained in combination.

As the polyol component, mainly used are, for example, dihydric alcohols such as ethylene glycol, diethylene glycol, propylene glycol, 1,4-butanediol, neopentyl glycol, 3-methylpentanediol, 1,4-hexanediol, 1,6-hexanediol, cyclohexanediol, and bisphenol A. According to need, a trihydric or higher polyol such as glycerin, trimethylolethane, trimethylolpropane, or pentaerythritol may be further contained in combination. These polyols may be used alone or as a mixture of two or more.

Commercially available examples of the saturated polyester resin (A1) include Vylon 300, Vylon 500, Vylon 560, Vylon 600, Vylon 630, Vylon 650, Vylon 670, Vylon GK 130, Vylon GK 140, Vylon GK 150, Vylon GK 190, Vylon GK 330, Vylon GK 590, Vylon GK 680, Vylon GK 780, Vylon GK 810, and Vylon GK 890, which are manufactured by Toyobo Co., Ltd.; Elitel UE-3220, Elitel UE-3500, Elitel UE-3210, Elitel UE-3215, Elitel UE-3216, Elitel UE-3620, Elitel UE-3240, Elitel UE-3250, and Elitel UE-3300, which are manufactured by Unitika Ltd.; and Alonmelt PES-310, Alonmelt PES-318, and Alonmelt PES-334, which are manufactured by ToaGosei Co., Ltd. (these are all trade names).

In the present invention, the saturated polyester resin (A2) having a number average molecular weight of 5000 to 30000 and a Tg of 51 to 100° C. used in the colored adhesive layer has a similar composition to the saturated polyester resin (A1) described above.

Commercially available examples of the saturated polyester resin (A2) include Vylon 200, Vylon 226, Vylon 240, Vylon 245, Vylon 270, Vylon 280, Vylon 290, Vylon 296, Vylon 660, Vylon 885, Vylon GK 250, Vylon GK 360, Vylon GK 640, and Vylon GK 880, which are manufactured by Toyobo Co., Ltd.; Elitel UE-3200, Elitel UE-9200, Elitel UE-3201, Elitel UE-3203, Elitel UE-3350, Elitel UE-3370, Elitel UE-3380, Elitel UE-3600, Elitel UE-3980, Elitel UE-3660, Elitel UE-3690, Elitel UE-9600, and Elitel UE-9800, which are manufactured by Unitika Ltd.; and Alonmelt PES-316 and Alonmelt PES-360, which are manufactured by ToaGosei Co., Ltd. (these are all trade names).

The Tg of the saturated polyester resin (A1) having a low Tg is 5 to 50° C. When the Tg is lower than 5° C., the resin strength tends to be low, and also the blocking resistance tends to be low.

The Tg of the saturated polyester resin (A2) having a high Tg is 51 to 100° C. When the Tg is higher than 100° C., the resin layer cannot follow the forming process, and the adhesion of the film layer is readily decreased.

Here, it is usually suitable that the Tg of the saturated polyester resin (A1) having a low Tg be 30° C. or lower and desirably 25° C. or lower, and the Tg of the saturated polyester resin (A2) having a high Tg be 60° C. or higher and desirably 65° C. or higher.

In addition, when the number average molecular weights of both the saturated polyester resin (A1) and the saturated polyester resin (A2) are smaller than 5000, the resin layer cannot follow the base in a high-speed lamination, which may cause an adhesion defect. On the other hand, when the number average molecular weight is larger than 30000, since the coating viscosity is high, unevenness tends to occur in the coating surface during the coating. This causes unevenness in the lamination, which may result in an appearance defect.

The amount of the solid of the saturated polyester resin (A1) is preferably 40 to 60 parts by mass based on 100 parts by mass of the total solid of the saturated polyester resin (A1), the saturated polyester resin (A2), the etherified amino resin (B), the epoxy resin (C), and the strong acid compound (D). When the amount of the saturated polyester resin (A1) is smaller than 40 parts by mass, the resin layer cannot follow the forming process, which tends to cause a reduction in the adhesion of the film layer. On the other hand, when the amount is larger than 60 parts by mass, the resin strength tends to be low, and also the blocking resistance tends to be low.

The amount of the solid of the saturated polyester resin (A2) is preferably 20 to 40 parts by mass based on 100 parts by mass of the total solid of the saturated polyester resin (A1), the saturated polyester resin (A2), the etherified amino resin (B), the epoxy resin (C), and the strong acid compound (D). When the amount of the saturated polyester resin (A2) is smaller than 20 parts by mass, the resin strength tends to be low, and also the blocking resistance tends to be low. On the other hand, when the amount is larger than 40 parts by mass, the resin layer cannot follow the forming process, which tends to cause a reduction in the adhesion of the film layer.

The blending ratio of the saturated polyester resin (A1) and the saturated polyester resin (A2) is preferably (A1):(A2)=1:1 to 3:1 as a solid mass ratio. When the ratio of the saturated polyester resin (A2) is higher than the ratio of 1:1 with respect to the saturated polyester resin (A1), the Tg of the coating is high, which may cause a reduction in process followability and a defect in adhesion with the metal base. On the other hand, when the ratio of the saturated polyester resin (A2) is lower than the ratio of 3:1 with respect to the saturated polyester resin (A1), the Tg of the film is low, which may cause a reduction in blocking resistance.

A suitable etherified amino resin (B) contained in the colored adhesive layer is prepared by etherifying a methylolated amino resin with a suitable alcohol. In particular, highly etherified amino resins can be suitably used. Examples of the alcohol used for the etherification include methyl alcohol, ethyl alcohol, n-propyl alcohol, i-propyl alcohol, n-butyl alcohol, i-butyl alcohol, 2-ethylbutanol, and 2-ethylhexanol. As the amino resin, in particular, a methylolated melamine resin in which at least a part of the methylol groups is alkyl etherified can be suitably used.

Commercially available examples of the amino resin include Super Beckamine L-105-60, manufactured by DIC corporation; and Cymel 235, Cymel 300, Cymel 303, Cymel 370, and Cymel 325, manufactured by Mitsui Cytec, Ltd. (these are all trade names).

The amount of the solid of the etherified amino resin (B) is preferably 1 to 10 parts by mass based on 100 parts by mass of the total solid of the saturated polyester resin (A1), the saturated polyester resin (A2), the etherified amino resin (B), the epoxy resin (C), and the strong acid compound (D). When the amount of the etherified amino resin (B) is smaller than 1 part by mass, since the heat curing reaction is slow, the curing reaction does not sufficiently progress by the heat only during the lamination, which may cause a reduction in coagulation power of the coloring agent to reduce the adhesion. On the other hand, when the amount is larger than 10 parts by mass, though the velocity of the heat curing reaction is sufficiently high, the internal stress is increased. Therefore, the adhesion during the processing may be reduced. In addition, since the unreacted etherified amino resin remains in the adhesive layer, discoloration (retort whitening) may occur during the retort sterilization treatment.

The epoxy resin contained in the colored adhesive layer preferably has a number average molecular weight of 500 to 5000, and examples thereof include bisphenol A epoxy resins, bisphenol F epoxy resins, and phenol novolac epoxy resins. Among them, the phenol novolac epoxy resins are preferred because they do not contain bisphenol A and bisphenol F whose effects on the human body are concerns.

The bisphenol epoxy resin may be, for example, a resin obtained by condensing epichlorohydrin and bisphenol, in the presence of an acid or alkali catalyst (e.g., a phosphoric acid or ammonium salt catalyst system) according to need, to give a high-molecular-weight, or a resin obtained by polyaddition reaction of an epoxy resin and bisphenol.

Examples of the bisphenol include bis(4-hydroxyphenyl)methane [bisphenol E], 1,1-bis(4-hydroxyphenyl)ethane, 2,2-bis(4-hydroxyphenyl)propane [bisphenol A], 2,2-bis(4-hydroxyphenyl)butane [bisphenol B], bis(4-hydroxyphenyl)-1,1-isobutane, bis(4-hydroxy-tert-butyl-phenyl)-2,2-propane, p-(4-hydroxyphenyl)phenol, oxybis(4-hydroxyphenyl), sulfonylbis(4-hydroxyphenyl), 4,4′-dihydroxybenzophenone, and bis(2-hydroxynaphtyl)methane. The bisphenols may be used alone or as a mixture of two or more.

Commercially available examples of the bisphenol epoxy resin include JER 1004, JER 1007, JER 1009, and JER 1010, which are manufactured by Japan Epoxy Resin Co., Ltd.; AER 6097 and AER 6099, which are manufactured by Asahi Kasei Epoxy Co., Ltd.; and Epiclon 7050 and Epiclon 9050, which are manufactured by DIC Corp. (these are all trade names).

Commercially available examples of the phenol novolac epoxy resin include Epiclon N-665, Epiclon N-670, Epiclon N-673, Epiclon N-680, Epiclon N-690, Epiclon N-695, Epiclon N-730, Epiclon N-740, Epiclon N-770, Epiclon N-865, and Epiclon N-870, which are manufactured by DIC Corp.; XD-7855, which is manufactured by The Dow Chemical Company; and ECN-1273 and ECN-1299, which are manufactured by Asahi Kasei Epoxy Co., Ltd. (these are all trade names).

When the number average molecular weight of the epoxy resin (C) is less than 500, the reactivity with the etherified amino resin is low. Therefore, the resulting cross-linking is insufficient, and discoloration (retort whitening) and adhesion defect may occur during the retort sterilization treatment. Furthermore, by the same reason, there is a risk of blocking with a film coated with ink when the film is wound. On the other hand, the number average molecular weight is larger than 5000, the solution viscosity is high. Therefore, the laminating property and workability may be adversely affected.

The amount of the solid of the epoxy resin (C) is preferably 5 to 20 parts by mass based on 100 parts by mass of the total solid of the saturated polyester resin (A1), the saturated polyester resin (A2), the etherified amino resin (B), the epoxy resin (C), and the strong acid compound (D). When the amount of the epoxy resin (C) is smaller than 5 parts by mass, the corrosion resistance of damaged portions and the retort whitening resistance tend to be low. On the other hand, when the amount is larger than 20 parts by mass, the formability and the retort whitening resistance tend to be low.

As the coloring agent for the colored adhesive layer, an organic pigment is usually used.

Examples of the organic pigment include carbon blacks such as PRINTEX FP, PRINTEX F alpha, PRINTEX F80, and PRINTEX F85, which are manufactured by Degussa AG; yellow pigments such as PALIOTOL YELLOW K2270, which is manufactured by BASF SE, PV FAST YELLOW HG, PV FAST YELLOW HGR, and PV FAST YELLOW H3R, which are manufactured by CLARIANT Corp., and CROMOPHTAL YELLOW 3RT, CROMOPHTAL YELLOW GPR, CROMOPHTAL YELLOW 3G, and CROMOPHTAL YELLOW 4GV, which are manufactured by Ciba-Geigy AG; red pigments such as CINQUASIA Red BRT-790-D, CROMOPHTAL Red 2020, CROMOPHTAL Red 2080, CROMOPHTAL Red 2030, CROMOPHTAL Red A2B, CROMOPHTAL Red A3B, CROMOPHTAL Red G, IRGALITE Red 2030, MICROLEN Red 2020-MC, MICROLEN Red 2028-MC, MICROLEN Red 2030-MC, MICROLEN Red A3B-MC, and MICROLEN Red RT-195-MC, which are manufactured by Ciba-Geigy AG; blue pigments such as CROMOPHTAL Blue 4GNP, IRGALITE Blue GA Granules, IRGALITE Blue LGLD, IRGALITE Blue NGA, IRGALITE Blue NGA-SG, MICROLEN Blue 4GNP-MC, MICROLITH Blue 4G-A, and MICROLITH Blue GS-T, which are manufactured by Ciba-Geigy AG; violet pigments such as CINQUASIA Violet R NRT-887-D and CINQUASIA Violet R RT-891-D, which are manufactured by Ciba-Geigy AG; and green pigments such as IRGALITE Green GFNP, IRGALITE Green GLN, and IRGALITE Green GLNP, which are manufactured by Ciba-Geigy AG (these are all trade names).

The amount of the coloring agent is not particularly limited, but in the cases of organic pigments, the amount of the solid is preferably about 1 to 10 parts by mass based on 100 parts by mass of the solid of the adhesive composition. When the amount of the organic pigment is smaller than 1 part by mass, the coloring effect is hardly exhibited. On the other hand, when the amount is larger than 10 parts by mass, the coloring pigment deposits on the interface of the resin film/colored adhesive layer by the heat during lamination, which may cause adhesion degradation and is undesirable from the standpoint of cost.

The strong acid compound contained in the colored adhesive layer accelerates the cross-linking reaction amount the polyester resin, the etherified amino resin, and the epoxy resin. The strong acid compound (D) functions as a curing catalyst that accelerates the cross-linking reaction among the saturated polyester resins (A1) and (A2), the etherified amino resin (B), and the epoxy resin (C) by heating for a short period of time.

As the strong acid compound (D), sulfonic acid compounds and amine neutralized sulfonic acid compounds are suitable, and these may be used alone or in a combination. Typical examples of the sulfonic acid compounds include p-toluenesulfonic acid, dodecylbenzenesulfonic acid, dinonylnaphthalenesulfonic acid, and dinonylnaphthalenedisulfonic acid. Commercially available examples thereof include p-toluenesulfonic acid/alcohol mixtures such as Taycacure AC-700, which is manufactured by Tayca Corporation; cumenesulfonic acid/alcohol mixtures such as Taycacure AC-800, which is manufactured by Tayca Corporation; dodecylbenzenesulfonic acid/alcohol mixtures such as Nacure 5076, which is manufactured by King Industries, Inc. and Taycacure AC-400S, which is manufactured by Tayca Corporation; dinonylnaphthalenesulfonic acid/alcohol mixtures such as Nacure 1051, which is manufactured by King Industries, Inc. and Taycacure AC-901, which is manufactured by Tayca Corporation; and dinonylnaphthalenedisulfonic acid/alcohol mixtures such as Nacure 155, which is manufactured by King Industries, Inc. (these are all trade names).

The amount of the solid of the strong acid compound (D) is preferably 0.01 to 10 parts by mass based on 100 parts by mass of the total solid of the saturated polyester resin (A1), the saturated polyester resin (A2), the etherified amino resin (B), the epoxy resin (C), and the strong acid compound (D). When the amount of the strong acid compound (D) is smaller than 0.01 parts by mass, the curing reaction is slow, which may cause a degradation in blocking resistance during lamination. On the other hand, when the amount is larger than 10 parts by mass, the coloring agent is excessively cured, which may cause a reduction in processability.

When the strong acid compound (D) is not contained, a shortage of the cross-linking may cause a retort property defect, an adhesion defect, and a reduction in blocking resistance during high-temperature water treatment, as in the case that when the number average molecular weight of the epoxy resin (C) is smaller than 500, the reactivity with the etherified amino resin (B) is inferior, and the cross-linking is thereby insufficient.

The Colored adhesive layer may further contain an inorganic pigment such as precipitated barium sulfate or silica for further increasing blocking resistance and processability, according to need. The inorganic pigment is preferably fine particles of 5 μm or less.

The amount of the solid of the inorganic pigment is preferably about 1 to 200 parts by mass based on 100 parts by mass of the resin solid of the adhesive composition. When the amount of the inorganic pigment is smaller than 1 part by mass, the effect due to addition of the inorganic pigment hardly exhibits. On the other hand, an amount of larger than 200 parts by mass may deteriorate the adhesion after forming and the rust resistance of a damaged portion and also is undesirable from the standpoint of cost.

In the case of that the inorganic pigment is precipitated barium sulfate, the amount thereof is preferably about 1 to 100 parts by mass based on 100 parts by mass of the resin solid of the adhesive composition, and in the case of silica, the amount thereof is preferably about 0.1 to 2 parts by mass based on 100 parts by mass of the resin solid. In particular, the effect when a denatured phosphoric acid compound is also contained is notable. The blocking resistance can be improved by increasing the apparent glass transition temperature due to pigment dispersion or increasing the roughness of the coating surface. In addition, it is suggested that the processability is improved by that the stress in the adhesive is suppressed by dispersing the pigment. Furthermore, the blocking resistance can be also improved by adding, for example, polyethylene or Teflon (registered trade mark). In addition, adhesion can be improved by the addition of various types of coupling agents.

The adhering amount of the adhesive after application and drying is preferably in the range of 0.1 to 5 g/m². An adhering amount smaller than 0.1 g/m² may cause a drawback in continuous uniform coating ability and a difficulty in exhibition of the design properties. In addition, the barrier property for water vapor in pressurized hot water treatment is inferior, which may allow moisture to stay in the adhesive/plastic film interface and cause retort whitening. On the other hand, when the amount is larger than 5 g/m², the solvent desorption after coating is low. This causes a significant reduction in workability and also readily causes a problem due to the remaining solvent, which may significantly reduce the blocking resistance during lamination.

Incidentally, the organic pigment added to the additive in the present invention is that complying with section 3297, part 178, title 21 of Code of Federal Regulations (CFR) based on Code of Federal Food, Drug, and Cosmetic Act set by US Food and Drug Administration (FDA) and is used as an adhesive composition for plastic film-laminated steel sheets that comply with section 300, part 175 of the above.

The polyester resin film on which the colored adhesive layer is coated will be described below.

In order to maintain favorable taste characteristic after heat treatment such as retort treatment, the polyester resin constituting the polyester resin film preferably has 93% by mole or more ethylene terephthalate units. In particular, a unit of 96% by mole or more can maintain the taste characteristic of a beverage, even if it is filled in a metal can for a long period of time, and is therefore desirable.

Simultaneously, the polyester resin may copolymerize another dicarboxylic acid component or glycol component within a range that does not impair the taste characteristic. Examples of the dicarboxylic acid component include aromatic dicarboxylic acids such as isophthalic acid, naphthalenedicarboxylic acid, diphenyldicarboxylic acid, diphenylsulfonedicarboxylic acid, diphenoxyethanedicarboxylic acid, 5-sodium sulphoisophthalic acid, and fumaric acid; aliphatic dicarboxylic acids such as oxalic acid, succinic acid, adipic acid, sebacic acid, dimer acid, maleic acid, and phthalic acid; alicyclic dicarboxylic acids such as cyclohexynedicarboxylic acid; and oxycarboxylic acids such as p-oxybenzoic acid.

Examples of the glycol component include aliphatic glycols such as propanediol, butanediol, pentanediol, hexanediol, and neopentyl glycol; alicyclic glycols such as cyclohexanedimethanol; aromatic glycols such as bisphenol A and bisphenol S; and diethylene glycol. These dicarboxylic acid components and the glycol components may be used in a combination of two or more. Furthermore, the copolymer polyester may be copolymerized with a polyfunctional compound such as trimellitic acid, trimeric acid, or trimethylolpropane as long as the effects of the present invention are not impaired.

The melting point of the polyester resin used in the present invention is preferably 246 to 280° C. and further preferably 250 to 275° C. When the melting point is lower than 246° C., the heat resistance may be undesirably low. On the other hand, when the melting point is higher than 280° C., the laminating property and formability may be undesirably deteriorated.

The polyester resin film used in the present invention may contain a mixture of two or more of the above-mentioned polymers.

In addition, the polyester resin film may be composed of two or more resin layers.

The thickness of the polyester resin film is preferably 6 to 50 μm. When the thickness of the film is smaller than 6 μm, the rust resistance of a damaged portion and the retort whitening resistance tend to be low. On the other hand, the thickness is larger than 50 μm, the adhesion after forming tends to be low and is undesirable from the standpoint of cost.

The film for lamination in which the above-described colored adhesive layer is coated on the polyester resin film is applied to cover one or both surfaces of a metal plate. Usually, the film for lamination is applied to a metal plate so as to cover the surface that becomes the outside of a can. In this case, when the metal surface that becomes the inside of the can is covered with a laminate film, the film may have any structure. For example, a polyester or polyolefin film serving as the laminate film may contain a lubricant, an antioxidant, a heat stabilizer, an ultraviolet absorber, a pigment, a plasticizer, an antistatic agent, or a crystal nucleating agent, according to need.

The film on the inside of a can may be a multilayer film of two or more layers or further may be applied with an adhesive on the surface that comes into contact with the metal. The thickness of the film on the inside of a can is desirably about 6 to 100 μm. The lower limit of the thickness is restricted by the corrosion resistance against the contents in the can, and the upper limit is restricted by the cost.

Furthermore, a metal plate of which one surface is laminated with the film for lamination according to the present invention can be applied to a container such as a can by coating the non-laminated surface.

A preferred method for producing the colored laminated metal plate for containers of the present invention will be described below.

In the method for producing the colored laminated metal plate for containers of the present invention, first, a film for lamination is prepared by laminating a colored adhesive layer on a surface of a polyester resin film, and the film for lamination is laminated on a surface of a metal plate with the colored adhesive layer.

A method for forming (laminating) the colored adhesive layer on a surface of the polyester resin film will now be described. The components (such as the polyester resin) for the colored adhesive layer prescribed in the present invention are dissolved in an organic solvent to prepare a coating solution. The coating solution is applied on a film surface during or after forming the film, followed by drying.

Examples of the organic solvent for dissolving the components for the colored adhesive include aromatic hydrocarbon-based solvents such as toluene and xylene, ketone-based solvents such as methyl ethyl ketone and cyclohexane, and ester-based solvents such as ethyl acetate and ethylene glycol monoethyl ether acetate. These may be used alone or in a combination that are arbitrarily selected.

The application of the coating solution to the polyester resin film may be carried out by any known coating method such as a roll coater system, a die-coater system, a gravure system, a gravure off-set system, or a spray application system, but a gravure roller coating system is most preferred. The conditions for drying after the application of the coating solution are preferably a temperature of 80 to 170° C. for 20 to 180 seconds, particularly, a temperature of 80 to 150° C. for 60 to 120 seconds.

Furthermore, the colored adhesive layer may be applied to a surface of a metal plate, instead of the polyester resin film. However, since the coater for metal plates is expensive, it is preferable that the colored adhesive layer be applied to the polyester resin film.

The thus prepared film for lamination is laminated to a surface of a metal plate by, for example, as shown in FIG. 2, heating the metal plate to a certain temperature or more with a metal plate-heating apparatus (also called a metal band-heating apparatus) and pressure bonding a film for lamination to the surface of the metal plate with a laminate roller (compression roller) for thermal fusion bonding.

Preferred conditions for the laminating will be described below.

The temperature of the metal plate at the beginning of the thermal fusion is preferably within a range of +5° C. to +30° C. of the higher value of the melting point of the polyester resin film or the softening point of the colored adhesive layer (polyester resin). In order to ensure interlayer adhesion of the metal plate/colored adhesive layer/polyester resin film by the thermal fusion, heat flow of the resin in the adhesion interface is necessary. By controlling the temperature of the metal plate within the temperature range that is higher by 5° C. or more than the higher value of the melting point of the polyester resin film or the softening point of the colored adhesive layer (polyester resin), the resin allows heat flow between each layer, and the wetting of the resin in a melted state in the interface becomes satisfactory to give satisfactory adhesion. On the other hand, even if the temperature is higher by more than 30° C. than the higher value, the effect of further improving the adhesion cannot be expected. In addition, the film is excessively melted to cause problems such as surface roughness due to embossing of the laminate roller surface and transfer of the meltage to the laminate roller (compression roller).

As the thermal history that the film receives during lamination, in order to obtain sufficient wettability in the interface, it is necessary that the period of time for which the polyester resin film and the colored adhesive layer (polyester resin) are in contact with each other at a temperature higher than the higher temperature of the melting point of the film and the softening point of the layer is 5 msec or more. The wettability is improved with an increase in the contacting time, but the performance becomes approximately the same when the period of time is longer than 40 msec. Therefore, a contacting time longer than 40 msec causes a reduction in productivity, and the contacting time is desirably 40 msec or shorter. From these reasons, the contacting time is preferably 5 to 40 msec.

In order to achieve such laminating conditions, in addition to high speed operation at 150 mpm or more, cooling during thermal fusion is also necessary. For example, the laminate rollers (compression rollers) in FIG. 2 are an inner water cooling system, in which the film and the colored adhesive layer can be prevented from being excessively heated, by letting cooling water through. Furthermore, the thermal histories of the polyester resin film and the colored adhesive layer can be controlled by changing the temperature of the cooling water.

The pressure applied by the laminate rollers is preferably 9.8 to 294 N/cm² (1 to 30 kgf/cm²) as the surface pressure. When the applied pressure is less than 9.8 N/cm², even if the temperature at the beginning of the thermal fusion is higher by 5° C. or more than the melting point of the film and sufficient fluidity can be ensured, the force for extending the resin on the metal surface is insufficient to give an inferior coating property. As a result, it is concerned that the performance qualities such as adhesion and corrosion resistance are adversely affected. On the other hand, when the applied pressure is higher than 294 N/cm², though the quality of the laminated metal plate is not adversely affected, the apparatus is increased in size, which is uneconomic. From these reasons, the pressure applied by the laminate rollers is preferably 9.8 to 294 N/cm².

The colored laminated metal plate for containers after passing through the laminate rollers is at a high temperature of about 200° C. Therefore, if the metal plate is directly wound as a coil, film fusion or blocking occurs in coil wraps. Therefore, it is necessary to cool the metal plate by, for example, cooling with water using a water quencher.

According to the method of producing the colored laminated metal plate for containers as describe above, a laminated metal plate that is prevented form the retort blushing and has a colored appearance, such as gold/brilliant colors, excellent in smoothness and film adhesion in strict processing application can be produced.

### EXAMPLES

### [Production of Film for Lamination]

The structures of each resin film and a colored adhesive layer to be coated on the resin film are shown in Tables 1 to 6.

Components for the colored adhesive layers were blended under conditions shown in Tables 1 to 6, and the resulting mixtures were each dissolved in a solvent mixture of toluene and methyl ethyl ketone to prepare coating solutions. The coating solutions were respectively applied to one surface of the corresponding resin films shown in Tables 1 to 6 with a gravure roll coater, followed by drying at 80 to 120° C. The colored adhesive layers were thus formed on the surfaces of the resin films to produce films for lamination.

### [Production of Colored Laminated Steel Sheet for Containers]

A chromium plated steel sheet (TFS: tin-free steel) was used as the metal plate. A cool rolled steel sheet having a thickness of 0.21 mm was degreased and pickled and then was chromium plated in a chromium plating bath containing CrO₃, F⁻, and SO₄²⁻. After intermediate rinsing, electrolytic treatment was conducted in a chemical conversion coating solution containing CrO₃ and F⁻. On this occasion, the electrolysis conditions (for example, current density and electrical quantity) were adjusted so that the chromium metal adhering amount and the hydrated chromium oxide adhering amount were, respectively, 120 mg/m² and 15 mg/m², in terms of Cr.

A resin film was laminated on the chromium plated steel sheet by the following manner with the metal plate laminating equipment (also called a metal band laminating equipment) shown in FIG. 2.

The above-described film for lamination was pressure bonded using a laminate roller (compression roller) to one surface (steel sheet surface to be the outside of a can) of the chromium plated steel sheet heated with a metal plate-heating apparatus so that the film was laminated to the chromium plated steel sheet surface by thermal fusion bonding, followed by water-cooling with a cooler. Thus, a colored laminated steel sheet was produced.

The laminate roller was an inner water cooling system, and the cooling during film adhesion was conducted by circulating cooling water during lamination. The period of time for which the film temperature in the interface where the film for lamination and the chromium plated steel sheet were in contact with each other was kept to a temperature not lower than the melting point of the film was within the range of 1 to 20 msec.

### [Performance Evaluation of Film for Lamination and Laminated Steel Sheet]

### (1) Blocking Resistance of Film for Lamination

The ink coating surfaces of sample films of 8 cm by 8 cm were bonded to each other. The films were left in the atmosphere of a pressure of 0.3 MPa and a temperature of 40° C. for 72 hours, and then the peeling strength when the bonded films were peeled from each other at a peeling rate of 1000 mm/min and a peeling angle of 180° was measured.

### (2) Performance Evaluation of Laminated Steel Sheet

### (2-1) Laminate Appearance

The appearance, such as generation of voids and wrinkles in film, of the laminated steel sheet was visually observed to evaluate based on the following criteria:

[symbol] : excellent,

◯: good,

Δ: slightly poor, and

×: poor.

### (2-2) Degree of Color Development

The b values measured with “spectrophotometer SE2000”, manufactured by Nippon Denshoku Industries Co., Ltd., were used (complying with JIS Z8722).

### (2-3) Adhesion: Cross-Cut/Cellophane Adhesive Tape Peeling Test

A laminated steel sheet film was cross-cut and was subjected to high-temperature water treatment at 125° C. for 30 minutes. Then, adhesion of the film was evaluated by the peeled area proportion when the forcedly peeled with cellophane adhesive tape (complying with JIS G3312).

### (2-4) Hot Water Resistance

The laminated steel sheet after the high-temperature water treatment at 125° C. for 30 minutes was visually investigated for whitening of the adhesive layer and was evaluated based on the following evaluation criteria:

[symbol] : excellent,

◯: good,

Δ: slightly poor, and

×: poor.

### (3) Evaluation of Formability and Quality Evaluation After Forming

### (3-1) Formability

The laminated steel sheet was applied with wax and was then punched out to a circular plate having a diameter of 200 mm. The plate was formed into a shallow drawing can at a drawing ratio of 2.0. Then, the shallow drawing can was further drawn at a drawing ratio of 2.20 and further at a drawing ratio of 2.5. After this, doming was conducted according to a usual manner, and then trimming was performed. Then, neck-in flange working was applied to form a deep drawing can. The neck-in portion of the thus prepared deep drawing can was visually investigated for the degree of damage of the film and was evaluated based on the following evaluation criteria:

[symbol] : no damage is observed at all in the film after forming,

◯: no damage is observed in the film after forming, but whitening is partially observed,

Δ: forming is possible, but film damage is partially observed, and

×: body breakage occurs in a can, and forming is impossible.

### (3-2) Adhesion After Forming

The cans that were formed in the formability evaluation were filled with tap water and then were sealed by seaming ends. Then, after the retort sterilization treatment at 125° C. for 90 minutes, samples (width: 15 mm, length: 120 mm) for a peeling test were cut out from the can bodies. A part of film was peeled from the end portion in the long side of each of the cut-out samples. The peeled film was opened in the opposite direction (angle: 180°) of the peeled direction for the peeling test at a tension rate of 30 mm/min using a tensile tester. The adhesion per 15 mm width was evaluated by the following evaluation criteria:

[symbol] : 10 N/15 mm or more,

◯: 5 N/15 mm or more and less than 10 N/15 mm, and

×: less than 5 N/15 mm.

### (3-3) Retort Whitening

The cans that were satisfactory in the formability in the (3-1) were filled with tap water of ordinary temperature and were sealed by seaming ends. Then, the cans were placed in a retort sterilization furnace such that the can bottoms face the downward side and were subjected to retort sterilization treatment at 125° C. for 60 minutes. The cans were taken out from the retort treatment furnace and were left for cooling. After the cans were cooled to near ordinary temperature, the change in appearance of the outside of the can bottom was visually observed and was evaluated based on the following criteria:

[symbol] : no change in appearance,

◯: slight cloudiness or discoloration,

Δ: white turbidity, and

×: white turbidity on whole surface.

### (3-4) Damaged Portion Rust Resistance

The cans formed in the (3-1) were scratched with a cutter at a position of 5 mm from the upper end of each can so that scratches having a length of about 10 mm were formed on halfway around the can at about 5 mm intervals. On this occasion, it was confirmed that the scratches certainly reached the base. Then, the cans were subjected to retort treatment at 125° C. for 90 minutes as in the previous retort sterilization treatment. Then, the cans were put in a salt spray tester (35° C.) for one hour and then put in a constant temperature and constant humidity tank that was kept at a temperature of 45° C. or higher and a humidity of 85% or higher to start a storage test. The cans were taken out from the constant temperature and constant humidity tank 240 hours after the start of the storage and were visually investigated for the rusting state in the vicinity of the scratched portion formed on each can body. Evaluation was performed based on the following evaluation criteria:

[symbol] : rust is observed at scratched portions, but no development of the damage,

◯: sign of floating of a film is observed in the vicinity of scratched portions for example, discoloration of the film),

Δ: a film floats in a width of several millimeters or more in the vicinity of scratched portions, and rust is developing under the film, and

×: a film is completely peeled and dropped off, and rust is developing.

Tables 7 and 8 show the results of the performance evaluation above. As shown in Tables, in the present invention, the formability as a two-piece can and adhesion after forming are excellent, and design properties are not deteriorated even after retort sterilization treatment to give satisfactory quality. In addition, it is confirmed that the rust resistance of the damaged portion on the outside of the can is notably improved, so that peeling of films associated with rust development, which is a disadvantage of laminated metal plates, can be prevented.

TABLE 1

| | | | Colored adhesive layer | | |
|---|---|---|---|---|---|
| No. | | Resin film | Low Tg polyester resin *1 | High Tg polyester resin *1 | Curing agent |
| Example 1 | Composition | Polyester resin film | “Vylon 300” *2 | “Vylon 200” *2 | Etherified amino resin: |
| | | (PET: 12 μm | Tg: 7° C. | Tg: 67° C. | “Cymel 303” *3 |
| | | thickness) | M.W.: 23,000 | M.W.: 17,000 | |
| | Blending amount | — | 53.9 parts by mass | 30 parts by mass | 6 parts by mass |
| Example 2 | Composition | Polyester resin film | “Vylon 300” *2 | “Vylon 200” *2 | Etherified amino resin: |
| | | (PET: 12 μm | Tg: 7° C. | Tg: 67° C. | “Cymel 303” *3 |
| | | thickness) | M.W.: 23,000 | M.W.: 17,000 | |
| | Blending amount | — | 43.9 parts by mass | 40 parts by mass | 6 parts by mass |
| Example 3 | Composition | Polyester resin film | “Vylon 300” *2 | “Vylon 200” *2 | Etherified amino resin: |
| | | (PET: 12 μm | Tg: 7° C. | Tg: 67° C. | “Cymel 303” *3 |
| | | thickness) | M.W.: 23,000 | M.W.: 17,000 | |
| | Blending amount | — | 63.9 parts by mass | 20 parts by mass | 6 parts by mass |
| Example 4 | Composition | Polyester resin film | “Vylon 300” *2 | “Vylon 200” *2 | Etherified amino resin: |
| | | (PET: 12 μm | Tg: 7° C. | Tg: 67° C. | “Cymel 303” *3 |
| | | thickness) | M.W.: 23,000 | M.W.: 17,000 | |
| | Blending amount | — | 75.9 parts by mass | 8 parts by mass | 6 parts by mass |
| Example 5 | Composition | Polyester resin film | “Vylon UR8300” *2 | “Vylon 200” *2 | Etherified amino resin: |
| | | (PET: 12 μm | Tg: 23° C. | Tg: 67° C. | “Cymel 303” *3 |
| | | thickness) | M.W.: 30,000 | M.W.: 17,000 | |
| | Blending amount | — | 53.9 parts by mass | 30 parts by mass | 6 parts by mass |
| Example 6 | Composition | Polyester resin film | “Vylon GK130” *2 | “Vylon 200” *2 | Etherified amino resin: |
| | | (PET: 12 μm | Tg: 15° C. | Tg: 67° C. | “Cymel 303” *3 |
| | | thickness) | M.W.: 7,000 | M.W.: 17,000 | |
| | Blending amount | — | 53.9 parts by mass | 30 parts by mass | 6 parts by mass |

| | | Colored adhesive layer | | | |
|---|---|---|---|---|---|
| | | | | | Adhesive adhering amount |
| No. | | Epoxy resin *1 | Curing catalyst | Organic pigment | (g/m²) |
| Example 1 | Composition | “JER1004” *4 | Strong acid compound: | “PALITAOL YELLOW | 1.5 |
| | | Bisphenol-type | dodecylbenzenesulfonic acid | K2270” *7 | |
| | | M.W.: 1400 | “Nacure 5076” *6 | | |
| | Blending amount | 10 parts by mass | 0.1 parts by mass | 4 parts by mass | |
| Example 2 | Composition | “JER1004” *4 | Strong acid compound: | “PALITAOL YELLOW | 1.6 |
| | | Bisphenol-type | dodecylbenzenesulfonic acid | K2270” *7 | |
| | | M.W.: 1400 | “Nacure 5076” *6 | | |
| | Blending amount | 10 parts by mass | 0.1 parts by mass | 4 parts by mass | |
| Example 3 | Composition | “JER1004” *4 | Strong acid compound: | “PALITAOL YELLOW | 1.7 |
| | | Bisphenol-type | dodecylbenzenesulfonic acid | K2270” *7 | |
| | | M.W.: 1400 | “Nacure 5076” *6 | | |
| | Blending amount | 10 parts by mass | 0.1 parts by mass | 4 parts by mass | |
| Example 4 | Composition | “JER1004” *4 | Strong acid compound: | “PALITAOL YELLOW | 1.5 |
| | | Bisphenol-type | dodecylbenzenesulfonic acid | K2270” *7 | |
| | | M.W.: 1400 | “Nacure 5076” *6 | | |
| | Blending amount | 10 parts by mass | 0.1 parts by mass | 4 parts by mass | |
| Example 5 | Composition | “JER1004” *4 | Strong acid compound: | “PALITAOL YELLOW | 1.6 |
| | | Bisphenol-type | dodecylbenzenesulfonic acid | K2270” *7 | |
| | | M.W.: 1400 | “Nacure 5076” *6 | | |
| | Blending amount | 10 parts by mass | 0.1 parts by mass | 4 parts by mass | |
| Example 6 | Composition | “JER1004” *4 | Strong acid compound: | “PALITAOL YELLOW | 1.6 |
| | | Bisphenol-type | dodecylbenzenesulfonic acid | K2270” *7 | |
| | | M.W.: 1400 | “Nacure 5076” *6 | | |
| | Blending amount | 10 parts by mass | 0.1 parts by mass | 4 parts by mass | |

*1 M.W.: number average molecular weight
*2 Trade name, manufactured by Toyobo Co., Ltd.
*3 Trade name, manufactured by Mitsui Cytec, Ltd.
*4 Trade name, manufactured by Japan Epoxy Resin Co., Ltd.
*6 Trade name, manufactured by King Industries, Inc.
*7 Trade name, manufactured by BASF SE

TABLE 2

| | | | Colored adhesive layer | | |
|---|---|---|---|---|---|
| No | | Resin film | Low Tg polyester resin *1 | High Tg polyester resin *1 | Curing agent |
| Example 7 | Composition | Polyester resin film | “Vylon 300” *2 | “Vylon 200” *2 | Etherified amino resin: |
| | | (PET: 12 μm | Tg: 7° C. | Tg: 67° C. | “Cymel 303” *3 |
| | | thickness) | M.W.: 23,000 | M.W.: 17,000 | |
| | Blending amount | — | 53.9 parts by mass | 30 parts by mass | 6 parts by mass |
| Example 8 | Composition | Polyester resin film | “Vylon 300” *2 | “Vylon 200” *2 | Etherified amino resin: |
| | | (PET: 12 μm | Tg: 7° C. | Tg: 67° C. | “Cymel 303” *3 |
| | | thickness) | M.W.: 23,000 | M.W.: 17,000 | |
| | Blending amount | — | 33.9 parts by mass | 30 parts by mass | 6 parts by mass |
| Example 9 | Composition | Polyester resin film | “Vylon 300” *2 | “Vylon 200” *2 | Etherified amino resin: |
| | | (PET: 12 μm | Tg: 7° C. | Tg: 67° C. | “Cymel 303” *3 |
| | | thickness) | M.W.: 23,000 | M.W.: 17,000 | |
| | Blending amount | — | 45.9 parts by mass | 30 parts by mass | 6 parts by mass |
| Example 10 | Composition | Polyester resin film | “Vylon 300” *2 | “Vylon 200” *2 | Etherified amino resin: |
| | | (PET: 12 μm | Tg: 7° C. | Tg: 67° C. | “Cymel 303” *3 |
| | | thickness) | M.W.: 23,000 | M.W.: 17,000 | |
| | Blending amount | — | 63.9 parts by mass | 22 parts by mass | 6 parts by mass |
| Example 11 | Composition | Polyester resin film | “Vylon 300” *2 | “Vylon 200” *2 | Etherified amino resin: |
| | | (PET: 12 μm | Tg: 7° C. | Tg: 67° C. | “Cymel 303” *3 |
| | | thickness) | M.W.: 23,000 | M.W.: 17,000 | |
| | Blending amount | — | 68.9 parts by mass | 22 parts by mass | 6 parts by mass |
| Example 12 | Composition | Polyester resin film | “Vylon 300” *2 | “Vylon 200” *2 | Etherified amino resin: |
| | | (PET: 12 μm | Tg: 7° C. | Tg: 67° C. | “Cymel 303” *3 |
| | | thickness) | M.W.: 23,000 | M.W.: 17,000 | |
| | Blending amount | — | 53.9 parts by mass | 30 parts by mass | 6 parts by mass |

| | | Colored adhesive layer | | | |
|---|---|---|---|---|---|
| | | | | | Adhesive adhering amount |
| No | | Epoxy resin *1 | Curing catalyst | Organic pigment | (g/m²) |
| Example 7 | Composition | “Epiclon | Strong acid compound: | “PALITAOL YELLOW | 1.5 |
| | | N-740” *5 | dodecylbenzenesulfonic acid | K2270” *7 | |
| | | Phenol | “Nacure 5076” *6 | | |
| | | novolac-type | | | |
| | | M.W.: 700 | | | |
| | Blending amount | 10 parts by mass | 0.1 parts by mass | 4 parts by mass | |
| Example 8 | Composition | “JER1004” *4 | Strong acid compound: | “PALITAOL YELLOW | 1.6 |
| | | Bisphenol-type | dodecylbenzenesulfonic acid | K2270” *7 | |
| | | M.W.: 1400 | “Nacure 5076” *6 | | |
| | Blending amount | 30 parts by mass | 0.1 parts by mass | 4 parts by mass | |
| Example 9 | Composition | “JER1004” *4 | Strong acid compound: | “PALITAOL YELLOW | 1.9 |
| | | Bisphenol-type | dodecylbenzenesulfonic acid | K2270” *7 | |
| | | M.W.: 1400 | “Nacure 5076” *6 | | |
| | Blending amount | 18 parts by mass | 0.1 parts by mass | 4 parts by mass | |
| Example 10 | Composition | “JER1004” *4 | Strong acid compound: | “PALITAOL YELLOW | 1.8 |
| | | Bisphenol-type | dodecylbenzenesulfonic acid | K2270” *7 | |
| | | M.W.: 1400 | “Nacure 5076” *6 | | |
| | Blending amount | 8 parts by mass | 0.1 parts by mass | 4 parts by mass | |
| Example 11 | Composition | “JER1004” *4 | Strong acid compound: | “PALITAOL YELLOW | 1.5 |
| | | Bisphenol-type | dodecylbenzenesulfonic acid | K2270” *7 | |
| | | M.W.: 1400 | “Nacure 5076” *6 | | |
| | Blending amount | 3 parts by mass | 0.1 parts by mass | 4 parts by mass | |
| Example 12 | Composition | “JER1001” *4 | Strong acid compound: | “PALITAOL YELLOW | 1.7 |
| | | Bisphenol-type | dodecylbenzenesulfonic acid | K2270” *7 | |
| | | M.W.: 900 | “Nacure 5076” *6 | | |
| | Blending amount | 10 parts by mass | 0.1 parts by mass | 4 parts by mass | |

*1 M.W.: number average molecular weight
*2 Trade name, manufactured by Toyobo Co., Ltd.
*3 Trade name, manufactured by Mitsui Cytec, Ltd.
*4 Trade name, manufactured by Japan Epoxy Resin Co., Ltd.
*5 Trade name, manufactured by DIC Corp.
*6 Trade name, manufactured by King Industries, Inc.
*7 Trade name, manufactured by BASF SE

TABLE 3

| | | | Colored adhesive layer | | |
|---|---|---|---|---|---|
| No | | Resin film | Low Tg polyester resin *1 | High Tg polyester resin *1 | Curing agent |
| Example 13 | Composition | Polyester resin film | “Vylon 300” *2 | “Vylon 200” *2 | Etherified amino resin: |
| | | (PET: 12 μm | Tg: 7° C. | Tg: 67° C. | “Cymel 303” *3 |
| | | thickness) | M.W.: 23,000 | M.W.: 17,000 | |
| | Blending amount | — | 53.9 parts by mass | 30 parts by mass | 6 parts by mass |
| Example 14 | Composition | Polyester resin film | “Vylon 300” *2 | “Vylon 200” *2 | Etherified amino resin: |
| | | (PET: 12 μm | Tg: 7° C. | Tg: 67° C. | “Cymel 303” *3 |
| | | thickness) | M.W.: 23,000 | M.W.: 17,000 | |
| | Blending amount | — | 47.9 parts by mass | 27 parts by mass | 15 parts by mass |
| Example 15 | Composition | Polyester resin film | “Vylon 300” *2 | “Vylon 200” *2 | Etherified amino resin: |
| | | (PET: 12 μm | Tg: 7° C. | Tg: 67° C. | “Cymel 303” *3 |
| | | thickness) | M.W.: 23,000 | M.W.: 17,000 | |
| | Blending amount | — | 47.9 parts by mass | 32 parts by mass | 10 parts by mass |
| Example 16 | Composition | Polyester resin film | “Vylon 300” *2 | “Vylon 200” *2 | Etherified amino resin: |
| | | (PET: 12 μm | Tg: 7° C. | Tg: 67° C. | “Cymel 303” *3 |
| | | thickness) | M.W.: 23,000 | M.W.: 17,000 | |
| | Blending amount | — | 58.9 parts by mass | 30 parts by mass | 1 parts by mass |
| Example 17 | Composition | Polyester resin film | “Vylon 300” *2 | “Vylon 200” *2 | Etherified amino resin: |
| | | (PET: 12 μm | Tg: 7° C. | Tg: 67° C. | “Cymel 303” *3 |
| | | thickness) | M.W.: 23,000 | M.W.: 17,000 | |
| | Blending amount | — | 57.4 parts by mass | 32 parts by mass | 0.5 parts by mass |
| Example 18 | Composition | Polyester resin film | “Vylon 300” *2 | “Vylon 200” *2 | Etherified amino resin: |
| | | (PET: 12 μm | Tg: 7° C. | Tg: 67° C. | “Cymel 303” *3 |
| | | thickness) | M.W.: 23,000 | M.W.: 17,000 | |
| | Blending amount | — | 52.9 parts by mass | 31 parts by mass | 6 parts by mass |

| | | Colored adhesive layer | | | |
|---|---|---|---|---|---|
| | | | | | Adhesive adhering amount |
| No | | Epoxy resin *1 | Curing catalyst | Organic pigment | (g/m²) |
| Example 13 | Composition | “JER1009” *4 | Strong acid compound: | “PALITAOL YELLOW | 1.5 |
| | | Bisphenol-type | dodecylbenzenesulfonic acid | K2270” *7 | |
| | | M.W.: 3800 | “Nacure 5076” *6 | | |
| | Blending amount | 10 parts by mass | 0.1 parts by mass | 4 parts by mass | |
| Example 14 | Composition | “JER1004” *4 | Strong acid compound: | “PALITAOL YELLOW | 1.6 |
| | | Bisphenol-type | dodecylbenzenesulfonic acid | K2270” *7 | |
| | | M.W.: 1400 | “Nacure 5076” *6 | | |
| | Blending amount | 10 parts by mass | 0.1 parts by mass | 4 parts by mass | |
| Example 15 | Composition | “JER1004” *4 | Strong acid compound: | “PALITAOL YELLOW | 1.5 |
| | | Bisphenol-type | dodecylbenzenesulfonic acid | K2270” *7 | |
| | | M.W.: 1400 | “Nacure 5076” *6 | | |
| | Blending amount | 10 parts by mass | 0.1 parts by mass | 4 parts by mass | |
| Example 16 | Composition | “JER1004” *4 | Strong acid compound: | “PALITAOL YELLOW | 1.6 |
| | | Bisphenol-type | dodecylbenzenesulfonic acid | K2270” *7 | |
| | | M.W.: 1400 | “Nacure 5076” *6 | | |
| | Blending amount | 10 parts by mass | 0.1 parts by mass | 4 parts by mass | |
| Example 17 | Composition | “JER1004” *4 | Strong acid compound: | “PALITAOL YELLOW | 1.7 |
| | | Bisphenol-type | dodecylbenzenesulfonic acid | K2270” *7 | |
| | | M.W.: 1400 | “Nacure 5076” *6 | | |
| | Blending amount | 10 parts by mass | 0.1 parts by mass | 4 parts by mass | |
| Example 18 | Composition | “JER1004” *4 | Strong acid compound: | “PALITAOL YELLOW | 1.6 |
| | | Bisphenol-type | dodecylbenzenesulfonic acid | K2270” *7 | |
| | | M.W.: 1400 | “Nacure 5076” *6 | | |
| | Blending amount | 10 parts by mass | 0.1 parts by mass | 1 part by mass | |

*1 M.W.: number average molecular weight
*2 Trade name, manufactured by Toyobo Co., Ltd.
*3 Trade name, manufactured by Mitsui Cytec, Ltd.
*4 Trade name, manufactured by Japan Epoxy Resin Co., Ltd.
*6 Trade name, manufactured by King Industries, Inc.
*7 Trade name, manufactured by BASF SE

TABLE 4

| | | | Colored adhesive layer | | |
|---|---|---|---|---|---|
| No | | Resin film | Low Tg polyester resin *1 | High Tg polyester resin *1 | Curing agent |
| Example 19 | Composition | Polyester resin film | “Vylon 300” *2 | “Vylon 200” *2 | Etherified amino resin: |
| | | (PET: 12 μm | Tg: 7° C. | Tg: 67° C. | “Cymel 303” *3 |
| | | thickness) | M.W.: 23,000 | M.W.: 17,000 | |
| | Blending amount | — | 52.9 parts by mass | 31 parts by mass | 6 parts by mass |
| Example 20 | Composition | Polyester resin film | “Vylon 300” *2 | “Vylon 200” *2 | Etherified amino resin: |
| | | (PET: 12 μm | Tg: 7° C. | Tg: 67° C. | “Cymel 303” *3 |
| | | thickness) | M.W.: 23,000 | M.W.: 17,000 | |
| | Blending amount | — | 53.9 parts by mass | 30 parts by mass | 6 parts by mass |
| Example 21 | Composition | Polyester resin film | “Vylon 300” *2 | “Vylon 200” *2 | Etherified amino resin: |
| | | (PET: 12 μm | Tg: 7° C. | Tg: 67° C. | “Cymel 303” *3 |
| | | thickness) | M.W.: 23,000 | M.W.: 17,000 | |
| | Blending amount | — | 53.9 parts by mass | 30 parts by mass | 6 parts by mass |
| Example 22 | Composition | Polyester resin film | “Vylon 300” *2 | “Vylon 200” *2 | Etherified amino resin: |
| | | (PET: 55 μm | Tg: 7° C. | Tg: 67° C. | “Cymel 303” *3 |
| | | thickness) | M.W.: 23,000 | M.W.: 17,000 | |
| | Blending amount | — | 53.9 parts by mass | 30 parts by mass | 6 parts by mass |
| Example 23 | Composition | Polyester resin film | “Vylon 300” *2 | “Vylon 200” *2 | Etherified amino resin: |
| | | (PET: 75 μm | Tg: 7° C. | Tg: 67° C. | “Cymel 303” *3 |
| | | thickness) | M.W.: 23,000 | M.W.: 17,000 | |
| | Blending amount | — | 53.9 parts by mass | 30 parts by mass | 6 parts by mass |

| | | Colored adhesive layer | | | |
|---|---|---|---|---|---|
| | | | | | Adhesive adhering amount |
| No | | Epoxy resin *1 | Curing catalyst | Organic pigment | (g/m²) |
| Example 19 | Composition | “JER1004” *4 | Strong acid compound: | “PALITAOL YELLOW | 1.6 |
| | | Bisphenol-type | dodecylbenzenesulfonic acid | K2270” *7 | |
| | | M.W.: 1400 | “Nacure 5076” *6 | | |
| | Blending amount | 10 parts by mass | 0.1 parts by mass | 0.5 parts by mass | |
| Example 20 | Composition | “JER1004” *4 | Strong acid compound: | “PALITAOL YELLOW | 6.2 |
| | | Bisphenol-type | dodecylbenzenesulfonic acid | K2270” *7 | |
| | | M.W.: 1400 | “Nacure 5076” *6 | | |
| | Blending amount | 10 parts by mass | 0.1 parts by mass | 4 parts by mass | |
| Example 21 | Composition | “JER1004” *4 | Strong acid compound: | “PALITAOL YELLOW | 0.08 |
| | | Bisphenol-type | dodecylbenzenesulfonic acid | K2270” *7 | |
| | | M.W.: 1400 | “Nacure 5076” *6 | | |
| | Blending amount | 10 parts by mass | 0.1 parts by mass | 4 parts by mass | |
| Example 22 | Composition | “JER1004” *4 | Strong acid compound: | “PALITAOL YELLOW | 1.4 |
| | | Bisphenol-type | dodecylbenzenesulfonic acid | K2270” *7 | |
| | | M.W.: 1400 | “Nacure 5076” *6 | | |
| | Blending amount | 10 parts by mass | 0.1 parts by mass | 4 parts by mass | |
| Example 23 | Composition | “JER1004” *4 | Strong acid compound: | “PALITAOL YELLOW | 1.6 |
| | | Bisphenol-type | dodecylbenzenesulfonic acid | K2270” *7 | |
| | | M.W.: 1400 | “Nacure 5076” *6 | | |
| | Blending amount | 10 parts by mass | 0.1 parts by mass | 4 parts by mass | |

*1 M.W.: number average molecular weight
*2 Trade name, manufactured by Toyobo Co., Ltd.
*3 Trade name, manufactured by Mitsui Cytec, Ltd.
*4 Trade name, manufactured by Japan Epoxy Resin Co., Ltd.
*6 Trade name, manufactured by King Industries, Inc.
*7 Trade name, manufactured by BASF SE

TABLE 5

| | | | Colored adhesive layer | | |
|---|---|---|---|---|---|
| No | | Resin film | Low Tg polyester resin *1 | High Tg polyester resin *1 | Curing agent |
| Comparative | Composition | Polyester resin film | No adhesive layer | | |
| Example 1 | | (PET: 12 μm | | | |
| | | thickness) | | | |
| | Blending amount | — | | | |
| Comparative | Composition | Polyester resin film | “Vylon 300” *2 | — | Etherified amino resin: |
| Example 2 | | (PET: 12 μm | Tg: 7° C. | | “Cymel 303” *3 |
| | | thickness) | M.W.: 23,000 | | |
| | Blending amount | — | 83.9 parts by mass | — | 6 parts by mass |
| Comparative | Composition | Polyester resin film | — | “Vylon 200” *2 | Etherified amino resin: |
| Example 3 | | (PET: 12 μm | | Tg: 67° C. | “Cymel 303” *3 |
| | | thickness) | | M.W.: 17,000 | |
| | Blending amount | — | — | 83.9 parts by mass | 6 parts by mass |

| | | Colored adhesive layer | | | |
|---|---|---|---|---|---|
| | | | | | Adhesive adhering amount |
| No | | Epoxy resin *1 | Curing catalyst | Organic pigment | (g/m²) |
| Comparative | Composition | No adhesive layer | | | — |
| Example 1 | | | | | |
| | Blending amount | | | | |
| Comparative | Composition | “JER1004” *4 | Strong acid compound: | “PALITAOL YELLOW | 1.8 |
| Example 2 | | Bisphenol-type | dodecylbenzenesulfonic acid | K2270” *7 | |
| | | M.W.: 1400 | “Nacure 5076” *6 | | |
| | Blending amount | 10 parts by mass | 0.1 parts by mass | 4 parts by mass | |
| Comparative | Composition | “JER1004” *4 | Strong acid compound: | “PALITAOL YELLOW | 1.6 |
| Example 3 | | Bisphenol-type | dodecylbenzenesulfonic acid | K2270” *7 | |
| | | M.W.: 1400 | “Nacure 5076” *6 | | |
| | Blending amount | 10 parts by mass | 0.1 parts by mass | 4 parts by mass | |

*1 M.W.: number average molecular weight
*2 Trade name, manufactured by Toyobo Co., Ltd.
*3 Trade name, manufactured by Mitsui Cytec, Ltd.
*4 Trade name, manufactured by Japan Epoxy Resin Co., Ltd.
*6 Trade name, manufactured by King Industries, Inc.
*7 Trade name, manufactured by BASF SE

TABLE 6

| | | | Colored adhesive layer | | |
|---|---|---|---|---|---|
| No | | Resin film | Low Tg polyester resin *1 | High Tg polyester resin *1 | Curing agent |
| Comparative | Composition | Polyester resin film | “Vylon 300” *2 | “Vylon 200” *2 | — |
| Example 4 | | (PET: 12 μm | Tg: 7° C. | Tg: 67° C. | |
| | | thickness) | M.W,: 23,000 | M.W.: 17,000 | |
| | Blending amount | — | 64.9 parts by mass | 35 parts by mass | — |
| Comparative | Composition | Polyester resin film | “Vylon 300” *2 | “Vylon 200” *2 | — |
| Example 5 | | (PET: 12 μm | Tg: 7° C. | Tg: 67° C. | |
| | | thickness) | M.W.: 23,000 | M.W.: 17,000 | |
| | Blending amount | — | 53.9 parts by mass | 36 parts by mass | — |
| Comparative | Composition | Polyester resin film | — | “Elilel UE3200” *8 | Curing agent (a): |
| Example 6 | | (PET: 12 μm | | Tg: 65° C. | blocked isocyanate |
| | | thickness) | | M.W.: 16,000 | compound “Duranate |
| | | | | | TPA-B80E” *9 |
| | | | | | Curing agent (b): |
| | | | | | polyisocyanate |
| | | | | | compound “Duranate |
| | | | | | TPA-100” *9 |
| | Blending amount | — | — | 84.5 parts by mass | (a) 10 parts by mass |
| | | | | | (b) 5 parts by mass |

| | | Colored adhesive layer | | | |
|---|---|---|---|---|---|
| | | | | | Adhesive adhering amount |
| No | | Epoxy resin *1 | Curing catalyst | Organic pigment | (g/m²) |
| Comparative | Composition | — | Strong acid compound: | “PALITAOL YELLOW | 1.4 |
| Example 4 | | | dodecylbenzenesulfonic acid | K2270” *7 | |
| | | | “Nacure 5076” *6 | | |
| | Blending amount | — | 0.1 parts by mass | 5 parts by mass | |
| Comparative | Composition | “JER1004” *4 | Strong acid compound: | “PALITAOL YELLOW | 1.3 |
| Example 5 | | Bisphenol-type | dodecylbenzenesulfonic acid | K2270” *7 | |
| | | M.W.: 1400 | “Nacure 5076” *6 | | |
| | Blending amount | 10 parts by mass | 0.1 parts by mass | 4 parts by mass | |
| Comparative | Composition | — | oxidation catalyst dibutyltin | “PALITAOL YELLOW | 1.5 |
| Example 6 | | | dilaurate | K2270” *7 | |
| | Blending amount | — | 0.5 parts by mass | 4 parts by mass | |

*1 M.W.: number average molecular weight
*2 Trade name, manufactured by Toyobo Co., Ltd.,
*4 Trade name, manufactured by Japan Epoxy Resin Co., Ltd.
*6 Trade name, manufactured by King Industries, Inc.
*7 Trade name, manufactured by BASF SE
*8 Trade name, manufactured by Unilika Ltd.
*9 Trade name, manufactured by Asahi Kasai Corp.

TABLE 7

| | | | | | | Evaluation of formability and | | | |
|---|---|---|---|---|---|---|---|---|---|
| | | Performance evaluation of laminated steel sheet | | | | quality evaluation after forming | | | |
| | | | Degree of color | | | | Adhesion | | Damaged |
| | Blocking resistance | Laminate | development | | Hot water | | after | | portion rust |
| No | of film | appearance | (b value) | Adhesion | resistance | Formability | forming | Retort whitening | resistance |
| Example 1 | 25 | [symbol] | 32 | 0 | [symbol] | [symbol] | [symbol] | [symbol] | [symbol] |
| Example 2 | 17 | [symbol] | 31 | 6 | ◯ | ◯ | ◯ | ◯ | [symbol] |
| Example 3 | 60 | [symbol] | 32 | 0 | [symbol] | [symbol] | ◯ | [symbol] | ◯ |
| Example 4 | 83 | [symbol] | 30 | 0 | [symbol] | [symbol] | ◯ | [symbol] | ◯ |
| Example 5 | 27 | ◯ to Δ | 30 | 7 | ◯ | [symbol] | ◯ | ◯ | [symbol] |
| Example 6 | 32 | [symbol] | 30 | 9 | ◯ | [symbol] | ◯ | ◯ | [symbol] |
| Example 7 | 27 | [symbol] | 30 | 0 | [symbol] | [symbol] | [symbol] | [symbol] | [symbol] |
| Example 8 | 67 | [symbol] | 34 | 4 | ◯ | ◯ | ◯ | ◯ | [symbol] |
| Example 9 | 56 | [symbol] | 29 | 2 | ◯ | ◯ | ◯ | ◯ | ◯ |
| Example 10 | 42 | ◯ | 25 | 5 | ◯ | [symbol] | ◯ | ◯ | ◯ |
| Example 11 | 61 | ◯ | 32 | 7 | ◯ | [symbol] | ◯ | ◯ | ◯ |
| Example 12 | 28 | [symbol] | 31 | 0 | ◯ | [symbol] | [symbol] | [symbol] | [symbol] |
| Example 13 | 60 | ◯ | 30 | 0 | ◯ | ◯ | ◯ | ◯ | [symbol] |
| Example 14 | 15 | ◯ | 33 | 6 | ◯ | ◯ | ◯ | ◯ | [symbol] |
| Example 15 | 34 | [symbol] | 33 | 8 | ◯ | ◯ | ◯ | ◯ | [symbol] |

TABLE 8

| | | | | | | Evaluation of formability and | | | |
|---|---|---|---|---|---|---|---|---|---|
| | | Performance evaluation of laminated steel sheet | | | | quality evaluation after forming | | | |
| | | | Degree of color | | | | Adhesion | | Damaged |
| | Blocking resistance | Laminate | development | | Hot water | | after | | portion rust |
| No | of film | appearance | (b value) | Adhesion | resistance | Formability | forming | Retort whitening | resistance |
| Example 16 | 39 | [symbol] | 30 | 4 | ◯ | [symbol] | ◯ | ◯ | [symbol] |
| Example 17 | 55 | ◯ | 30 | 3 | ◯ | ◯ | ◯ | ◯ | ◯ |
| Example 18 | 24 | [symbol] | 15 | 0 | ◯ | [symbol] | [symbol] | [symbol] | [symbol] |
| Example 19 | 12 | [symbol] | 7 | 0 | [symbol] | [symbol] | [symbol] | [symbol] | [symbol] |
| Example 20 | 75 | ◯ | 34 | 0 | ◯ | ◯ | ◯ | ◯ | ◯ |
| Example 21 | 25 | ◯ | 6 | 0 | ◯ | [symbol] | ◯ | ◯ | ◯ |
| Example 22 | 19 | [symbol] | 32 | 0 | ◯ | ◯ | ◯ | ◯ | ◯ |
| Example 23 | 23 | [symbol] | 32 | 0 | ◯ | ◯ | ◯ | ◯ | ◯ |
| Comparative | — | ◯ | — | 9 | X | ◯ | ◯ | X | X |
| Example 1 | | | | | | | | | |
| Comparative | 60 | Δ | 25 | 14 | X | ◯ | X | X | X |
| Example 2 | | | | | | | | | |
| Comparative | 72 | [symbol] | 24 | 8 | Δ | ◯ | X | ◯ | Δ |
| Example 3 | | | | | | | | | |
| Comparative | 19 | [symbol] | 25 | 11 | Δ | Δ | X | ◯ | Δ |
| Example 4 | | | | | | | | | |
| Comparative | 65 | Δ | 20 | 11 | X | X | — | — | — |
| Example 5 | | | | | | | | | |
| Comparative | 80 | [symbol] | — | 20 | X | X | — | — | — |
| Example 6 | | | | | | | | | |

### INDUSTRIAL APPLICABILITY

The colored laminated metal plate of the present invention is excellent in deep drawability, film adhesion, adhesion after forming, rust resistance of a damaged portion, and so on. When the colored laminated metal plate is formed into a container such as a can, retort whitening hardly occurs in the laminate film, and the design properties of the appearance can be maintained. Therefore, the colored laminated metal plate of the present invention can be suitably applied to the use for containers in, for example, the can manufacturing industry and can therefore contribute significantly to the industries.

### REFERENCE NUMERALS

1 metal plate

2 colored adhesive layer

3 polyester resin film

4 film for lamination

5 metal plate-heating apparatus

6 roller

7a compression roller

7b compression roller

8 cooler

9 contents

10 condensed water

1. A colored laminated metal plate for containers, comprising a metal plate having one or both surfaces coated with a film for lamination in which a colored adhesive layer is coated to a polyester resin film, wherein
the colored adhesive layer contains a polyester resin as a main component and further contains an etherified amino resin, an epoxy resin, a strong acid compound, and a coloring agent.

2. The colored laminated metal plate for containers according to claim 1, wherein the colored adhesive layer contains a saturated polyester resin (A1) having a number average molecular weight of 5000 to 30000 and a Tg of 5 to 50° C., a saturated polyester resin (A2) having a number average molecular weight of 5000 to 30000 and a Tg of 51 to 100° C., an etherified amino resin (B), an epoxy resin (C) having a number average molecular weight of 500 to 5000, and a strong acid compound (D) of at least one selected from sulfonic acid compounds and amine neutralized sulfonic acid compounds; and the amount of the solid of the saturated polyester resin (A1) is 40 to 60 parts by mass, the amount of the solid of the saturated polyester resin (A2) is 20 to 40 parts by mass, the amount of the solid of the etherified amino resin (B) is I to 10 parts by mass, the amount of the solid of the epoxy resin (C) is 5 to 20 parts by mass, and the amount of the solid of the strong acid compound (D) is 0.01 to 10 parts by mass, based on 100 parts by mass of the total solid of the components (A1), (A2), (B), (C), and (D).

3. The colored laminated metal plate for containers according to claim 1, wherein the polyester resin constituting the polyester resin film includes a main repeating unit of ethylene terephthalate.

4. The colored laminated metal plate for containers according to claim 1, wherein the adhering amount of the colored adhesive layer is 0.1 to 5 g/m².

5. The colored laminated metal plate for containers according to claim 1, wherein the polyester resin film has a thickness of 6 to 50 μm.

6. The colored laminated metal plate for containers according to claim 1, wherein the epoxy resin contained in the colored adhesive layer is a phenol novolac epoxy resin.

7. The colored laminated metal plate for containers according to claim 1, wherein the colored adhesive layer contains an organic pigment as the coloring agent in an amount of the solid of 1 to 10 parts by mass based on 100 parts by mass of the solid of the adhesive composition.
